(19) United States
(12) Patent Application Publication
(10) Pub. No.: US 2007/0185599 A1
(43) Pub. Date: Aug. 9, 2007

(54) Sports player ranker

(75) Inventors: Shawn G. Robinson, San Jose, CA (US); Lukasz Wojewoda, Santa Monica, CA (US)

Correspondence Address: MORRISON & FOERSTER LLP, 755 PAGE MILL RD, PALO ALTO, CA, 94304-1018, US

(73) Assignee: Yahoo! Inc., Sunnyvale, CA (US)

(21) Appl. No.: 11/347,517

(22) Filed: Feb. 3, 2006

(51) Int. Cl. G06F 19/00

(52) U.S. Cl. 700/92

(57) ABSTRACT

In one example, a system for ranking sports players is provided. The system includes display logic operable to display two players from a plurality of players, and selection logic operable to store a selection of one of the two players by a user. The system further includes logic operable to rank the players based upon user selections of the players. The system may pair players, e.g., select a first player and a second player for display and selection by a user, based on their relative rankings. In one example, a first player is selected and the second player is selected based on the ranking of the first player such that closely ranked players are paired for selection by users with greater frequency than remotely ranked players.

### BACKGROUND

1. Field

The present invention relates generally to sports and ranking systems, and in one particular example, to ranking multiple players in a sports or fantasy sports context.

2. Related Art

Generally speaking, fantasy sports are virtual games where users, referred to often as owners, build a collection or “team” of players that compete against teams created by other users. The teams typically include players from a professional sport (e.g., football, soccer, baseball, basketball, hockey, etc.). The players accumulate points within the fantasy sport game based on their individual (and sometimes team) statistics, i.e., statistics from the actual player performances over time. For example, typically, a predetermined or agreed upon model is used to associate actual statistics of individual players into points. Teams thereby compete based on the number of points accumulated over a given period. The period may be based on a weekly schedule, number of games, season, etc.

A fantasy football league, for example, may include several teams of players selected by users. The players may be selected based on a “draft” or other means whereby the users select players generally based on their expected performance. Typically, a team Must draft a number of players for each position such as quarterback, running back, wide receiver, kicker, and so on. Generally, a large amount of research is performed by users in determining which players to select for their team.

Additionally, in some variations of fantasy sports the user has the option of substituting players in and out of a starting line-up. For example, some of an owner's team may “start”, i.e., are used to accumulate points for a particular cycle (e.g., on a given day, week, or game(s)) while other players are “benched”, i.e., are unused or left out of the point accumulations for the team. Continuing with the fantasy football example, an owner may have two quarterbacks that may be used in a given cycle, however, only one may “start” per cycle. The owner therefore chooses which player to start and which to bench. Accordingly, a person playing may expend a large amount of time researching and determining which players to start in a given cycle and which players to bench.

### SUMMARY

According to one aspect described herein a ranking system for sports players is provided. In one example, the system includes display logic operable to display two players from a plurality of players, and selection logic operable to store a selection of one of the two players by a user. The display logic may display multiple pairings or sets of two players for selection by the user. The system further includes logic operable to rank the players based upon user selections.

In some examples the system further includes logic operable to pair players, e.g., select a first player and a second player for display and selection by a user, based on their relative rankings. In one example, a first player is selected and the second player is selected based on the ranking of the first player. The first player may be randomly selected or the winner of a previous pairing, and the second player may be selected based on a probability distribution associated with the ranking of the first player such that more closely ranked players are paired with greater frequency than remotely ranked players.

In another example a sports player ranker system includes logic operable to rank a plurality of players based upon selections by a plurality of users, each of the selections comprising a selection of a player from a subset of the plurality of players. The subset may include a pairing of two players in a head-to-head match-up. In one example, the subset is formed by selecting a first player and selecting a second player based on the ranking of the first player.

In another aspect, a ranking system is provided for ranking items (which may include, among other things, sports players). In one example, a ranking system includes display logic operable to display two items, selection logic operable to store a selection of one of the two items by a user, and ranking logic operable to rank the items based upon selections of the items, wherein the display logic is operable to select a first item and a second item for display, the second item selected based on the ranking of the first item.

According to another aspect, an exemplary method is provided for ranking items (e.g., sports players). In one example, the method includes displaying subsets of players from a plurality of players, and ranking the plurality of players based upon select-ions of a player from the subsets.

According to another aspect, a computer program product comprising program code for ranking items (e.g., sports players) is provided. The computer program product may include program code operable to carry out the functions and methods described herein.

The various aspects and examples of the present inventions are better understood upon consideration of the detailed description below in conjunction with the accompanying drawings and claims.

### BRIEF DESCRIPTION OF THE DRAWINGS

FIG. 1 illustrates an exemplary environment in which certain aspects and examples of the systems and methods described may be carried out;

FIG. 2 illustrates an exemplary interface for selecting player preferences;

FIG. 3 illustrates another exemplary interface for selecting player preferences;

FIG. 4 illustrates an exemplary ranking of players based on previous player preference selections; and

FIG. 5 illustrates an exemplary method for ranking players based on user selected preferences.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

Fantasy sports game users often utilize various sources of information to determine which players to select, whether for drafts or to start for particular playing cycles/games. One such source of information includes on-line services, such as general news sources, sports news sources (e.g., Yahoo!® Sports), message boards, and the like. For example, a user may examine various sports related news cites to gather information and statistics for players in an effort to determine which players to draft, start/bench, and the like. Given the large amount of information generally available, a typical user may find gathering useful information difficult and time consuming.

A user may also visit message boards or other online forums to read posts and/or post queries regarding particular players in an effort to determine, for example, which players to draft, whether to start player A or player B for a particular game, and the like. Responses and postings, however, may be numerous and difficult to assimilate in any meaningful way.

According to one example described herein, a system is provided for selecting, ranking, and tracking preferences for particular players. Users are presented with selections of a subset of available players, e.g., two players or a particular position or the like, from which the user may select a preference of one of the players over the other(s). The selection may be stored and accumulated over multiple users to determine a ranking of players, where the highest ranking player corresponds generally to a player that has been or is selected most often when compared with other players, for example. In some examples, the subsets or pairings of players for selection by users is performed such that closely ranked players are displayed and selected from by users more often than distantly ranked players. Users may view overall rankings of various players as well as view results of head-to-head match-ups of particular players (e.g., player A versus player B).

It will be appreciated that although the ranking system is described herein for ranking players in a fantasy sports context, the exemplary systems and methods may be used to rank a variety of items such as media objects, movies, television shows, pictures, cars, web sites, products, people, celebrities, companies, and the like.

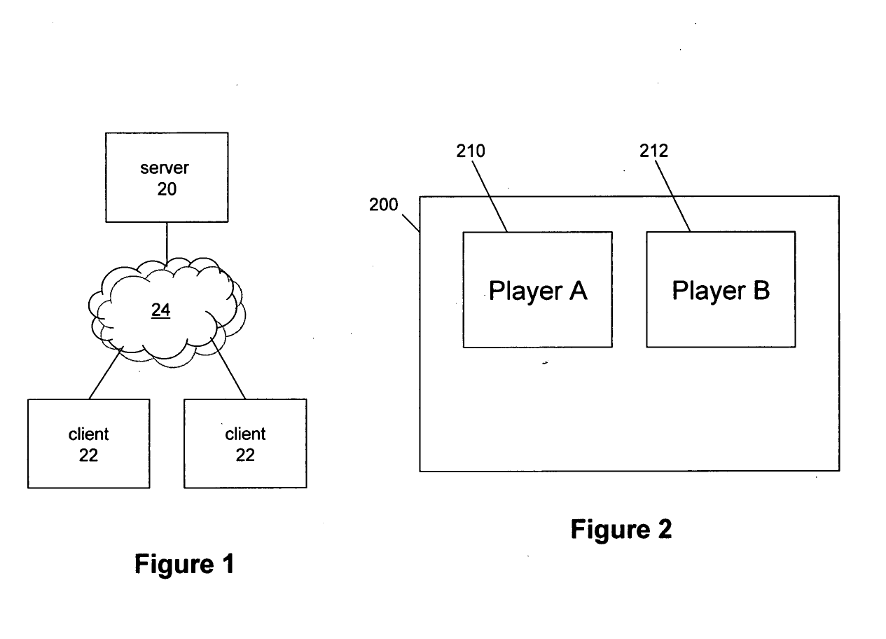

FIG. 1 illustrates a block diagram of an exemplary environment in which certain aspects of the system may operate. Generally, a plurality of clients 22 may access a server 20. The server 20 and clients 22 of the present invention may include any one of various types of computer devices, having, e.g., a processing unit, a memory (including a permanent storage device), and a communication interface, as well as other conventional computer components (e.g., input device, such as a keyboard and mouse, output device, such as display). For example, client computer 22 may include a desktop computer, laptop computer, mobile device such as a mobile phone, web-enabled phone, smart phone, and the like.

Clients 22 and server 20 may communicate, e.g., via suitable communication interfaces via a network 24, such as the Internet. Clients 22 and server 20 may communicate, in part or in whole, via wireless or hardwired communications, such as Ethernet, IEEE 802.11 b wireless, or the like. Additionally, communication between clients 22 and server 20 may include various servers such as a mail server, mobile server, and the like.

The server 20 is programmed to format data, accessed from local or remote databases or other sources of data, for presentation to users of clients 22, preferably in the format discussed in detail below. The server 20 may utilize various Web data interface techniques such as Common Gateway Interface (CGI) protocol and associated applications (or “scripts”), Java® “servlets”, i.e., Java applications running on the Web server, or the like to present information and receive input from clients 22. The server 20, although described herein in the singular, may actually comprise plural computers, devices, backends, and the like, communicating (wired and/or wireless) and cooperating to perform the functions described herein.

FIG. 2 illustrates an exemplary player ranker user interface 200 for selecting and registering user preferences of players. The player ranker system interface 200 may be stored as an application in any computer system; for example, the player ranker user interface 200 may operate on one or more computer devices, including stand alone computers, server computers connected to client computers over a network, and the like. In one particular example, the player ranker user interface 200 may run as an application on a server computer or computers (see, e.g., server 20 of FIG. 1). Users may access and input selections via client computers through a web browser or the like. Various other methods and systems for displaying and accessing the player ranker user interface 200 are contemplated.

The player ranker user interface 200 may be displayed, for example, in one or more windows on a computer screen, or in a Web browser. User interface 200 may have associated therewith computer program code in HyperText Markup Language (HTML), JavaScript®, Java®, combinations thereof, or any other form of computer-executable code, for causing the user interface elements shown in FIGS. 2-4 to be displayed to a user and to accept user interactions.

In one example, the process is initiated by a user typing into his or her browser the Uniform Resource Locator (URL) of the server Web site. In response to receipt of this communication from a participant's browser, software operating at the server controls the server to send the browser information associated with the user interface 200, preferably a Hypertext Mark-up Language (HTML) document, having features and functionality as discussed herein. An interactive session may follow, whereby the user may select/rank players, view player rankings, and the like. Additionally, depending on the implementation, various log-in and user identification methods and interfaces may be used as will be understood by those of ordinary skill in the art.

In one example, user interface 200 operates to display player 210 and player 212, which are selectable by the user. Player 210 and player 212 may include an icon, hyperlink, image, or other discernable indicia associated with player 210 and player 212. For example, player 210 and player 212 may include an image of the player, a text description of the player (e.g., name, number, team, etc.), or combinations thereof. Players 210 and 212 are generally selected and displayed from a set of players for a particular sport and position (as appropriate). For example, players 210 and 212 may be selected from a set of football quarterbacks, basketball centers, hockey defensemen, or the like. In particular, players 210 and 212 may include two quarterbacks.

A user may make a selection of one of the two players by moving a cursor over player 210 or 212 (whether an image, text, etc.) and selecting (e.g., clicking a mouse). In other examples, a box may be included and checked before hitting return on a keyboard or other indicator that the selection has been made.

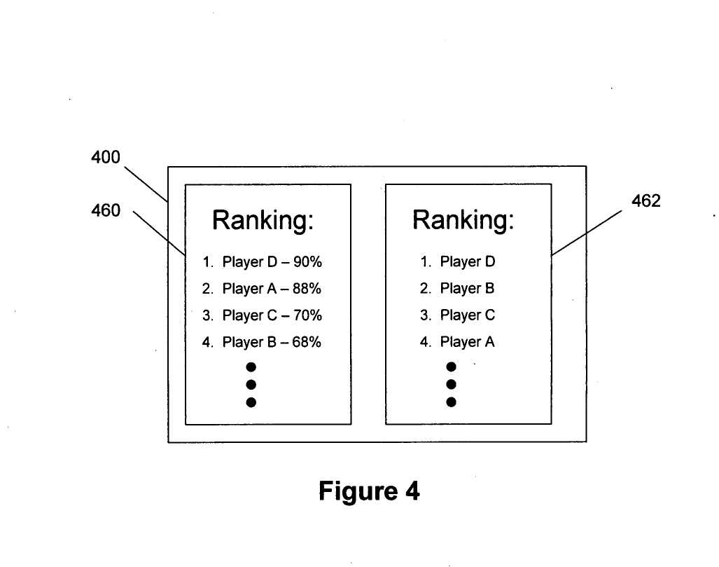

Selections of players are stored for the individual user as well as over multiple users to create both individualized user and composite rankings of players within the set of players (e.g., within the set of football quarterbacks, etc.). Users may access and view a ranking of players based on the individual user's selection as well as selections of multiple users (see, e.g., FIG. 4). Additionally, users may view results of a certain player in head-to-head selections by users against all other players, individual players, or other subsets of players.

As a user makes selections of one of player 210 or player 212, the selection is registered or stored. The user interface 200 continues to present a new pairing of players (which may include one of the original pairing of players) for selection by the user after a selection of player 210 or player 212 has been made. The new players may be randomly selected from the original set of players or from a new set of players. For example, a user may be interested in quarterbacks and therefore be presented subsequent subsets of quarterbacks for selection; in other examples, the pairings of players may change to a different position within the same sport, e.g., wide receivers.

The selection process by the user may be continued for a preset number of iterations or until the player combinations have been exhausted, for example. The system may have various implementations for use by users. For example, a user may view rankings or and/or head-to-head match-up results without first making selections. In other examples, the system may require the user to first make a prerequisite number of player selections (to ensure sufficient sampling for the ranking system, for example).

Players 210 and 212 may be presented to a user in a random pairing from a set of players (e.g., from a set of football quarterbacks). In other examples, however, the players 210 and 212 are presented from a set of players in a non-random fashion. In one example, players 210 and 212 are displayed for selection based on their rankings, e.g., closely ranked players, strongly/weakly ranked players, and the like. Such a system may help determine and distinguish players that are ranked closely by pairing players that are ranked relatively closely more often than players ranked relatively distantly. For example, if a set of players includes 50 player, the system may match players ranked 22^{nd} and 25^{th} more often than players ranked 1^{st} and 50^{th}.

In one example, the system may include an algorithm wherein a first player is selected randomly from a set of players. A second player, to be matched-up against the first player, is selected based (at least in part) by the rank of the first player. For example, in selecting the second player, players closely ranked to the first player are more heavily weighted than a random selection. This may be achieved by using a non-uniform probability distribution (i.e., a probability distribution that does not include equal probabilities for the remaining players) to select the second players. It is noted that the initial ranking in the system may be selected by the system (e.g., randomly, based on previous rankings, etc.), or each player may be seeded with the same ranking (a null ranking).

A non-uniform probability distribution represented, e.g., by a Gaussian or bell curve distribution may be used to determine the second player, the probability distribution associated with the first player's rank, for example. In one example, the probability distribution may be a Gaussian curve centered on the first player such that closely ranked players have a greater chance or probability of being selected and paired in a head-to-head match-up with the first player, and players with more remote rankings have a lesser chance or probability of being selected. The probability distribution in other examples may be non-Gaussian, skewed from the first player's rank, or the like. For example, if the first player is ranked near the top or bottom of the ranking, the probability distribution from which the second player is selected may be skewed or offset from the ranking of the first selected player.

Such a method and system may allow for an occasional match-up between a much lower (or higher) ranked player, which may help stabilize overall rankings, but the match-up is more likely to be with a player of a similar ranking. In one example, the player rankings are divided into “buckets” or percentile ranges, which will be matched-up in greater frequency within or close to the particular bucket than distant buckets. For example, each 10^{th} percentile may be grouped into a bucket. If a player ranks in the 60^{th} percentile, then the likelihood of a match-up with a player in the 50-79^{th} percentile is greater than matching up against a player in the 40-49^{th} or 80^{th}-89^{th} percentiles, which is further greater than the likelihood of 30-39^{th} and 90^{th}-100^{th} percentiles, and so on.

An exemplary table shown below may be used by the server and/or user interface to determine pairings (given a random or otherwise selection of the first player).

| | Players ranked within X of first | | | |
|---|---|---|---|---|
| | player ranking: | | | |
| | 0-10% | 10-20% | 20-30% | 40+% |
| % chance of second player | 50% | 30% | 15% | 5% |
| match-up within range: | | | | |

Thus, in this example, there is a 50% probability of the matched players having rankings within 10% of each other, and only a 5% change that they are separated by 40% or more. It will be clear to those of ordinary skill in the art that the percentile ranges, probabilities, etc. of how this is carried out may be altered for various applications and systems. For example, various functions and algorithms may be implemented where one or more parameters may be controlled to adjust the behavior of the system to be nearly random (e.g., a flat bell curve), a moderate bell curve, or to pair primarily only very closely ranked players (e.g. a steep bell curve). Additionally, in some examples, the system might only match-up players within a certain distance, e.g., within 10 percentile or “n” number of rankings and having zero probability of match-ups with players of greater ranking disparity.

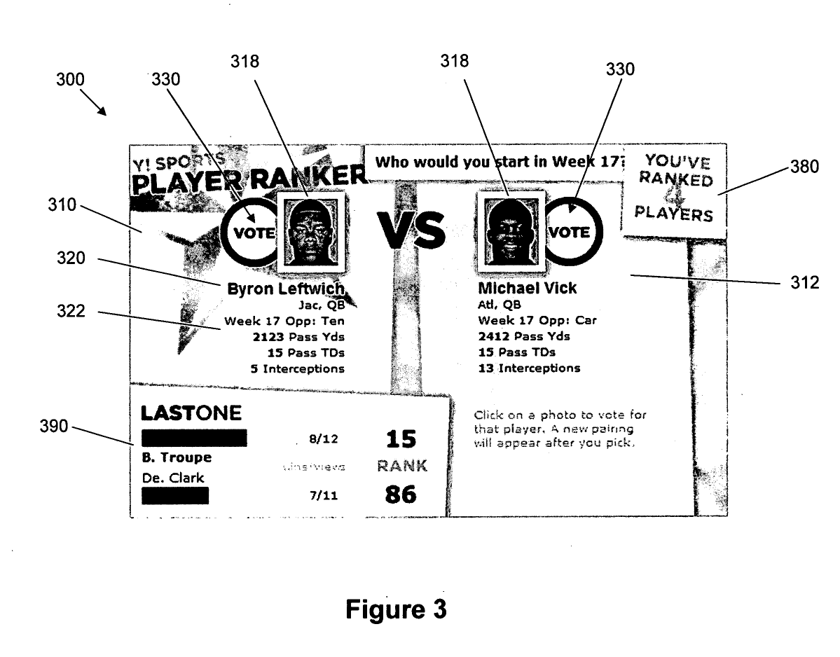

FIG. 3 illustrates an exemplary user interface 300 according to one illustrative example. In this example, user interface 300 displays a first player 310 including an image 318 of the player, name 320, and information 322 associated with the player 310. Information 322 may include position, team, past statistics, upcoming opponents, and the like. Additionally, each player 310 and 312 each include an icon 330 for voting or selecting that particular player.

Additionally, in this example, the previous selection results are shown at 390 and the number of players ranked by the particular user is shown at 380. The previous results at 390 may show who was previously selected (in this example, “B. Troupe” defeated “De Clark”), the ranking of both players within a particular set of players (e.g., 15^{th} and 86^{th}), their statistics (e.g., wins per match-up), and so on. e.g., their overall rankings within their set or subset of players. Further, the number of selections shown at 380 may be particularly relevant if the user interface and system are designed such that the user is encouraged or required to make a certain number of selections (e.g., prior to viewing overall rankings, etc.).

User interface 300 may be a window or embedded within a larger window of a browser application, for example. Various other information and options may be included. For Example, a “draw” option may be included, whereby the user passes and does not register a preference for either player and proceeds to the next pairing of players.

FIG. 4 illustrates an exemplary interface 400 illustrating a ranking of players based on previous player preference selections. In this example, the interface 400 includes a list 460 of players in order of their rank based on an aggregation of other user's selections along with their percentage of times they were selected by users in various pairings. List 460 may be divided by sport, position, and the like, and may be manipulated by the user. For example, interface 400 may include a drop-down menu or the like (not shown) to allow the user to view various rankings based on position, team, etc., or manipulate the collected statistics of user selections. A user may also select a particular player and view specific results and statistics for that player.

Additionally, in one example, interface 400 includes a list 462 of players based on the particular user's selection of players. The list 462 may be similarly manipulated by the user as desired.

Additionally, a user may view the results of particular pairings or head-to-head match-ups; for example, the selections by other users of the match-up of player A versus player B. As described, in some example, a user may input a first and second player and receive the results of previous match-up selections of the two players by other users. This features may be particular desirable in an example where player A is ranked higher than player B, however, in head-to-head match-ups, a majority of players selected player B over player A. Accordingly, a user may view both overall ranking of a player as well as head-to-head match-up statistics.

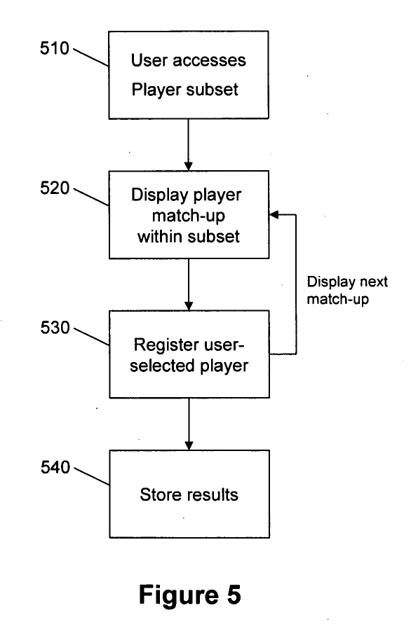

FIG. 5 illustrates an exemplary method for ranking a set of players based on user selected preferences. Initially, a system is seeded with a set of players, which may be divided or dividable into various subsets or categories such as sport, position, and the like. A user may access a particular set or subset of players at 510. For example, within a fantasy sports player ranker interface, a user may select a subset of football players. Additionally, the subset may be further divided into professional football players, quarterbacks, and so on.

In one example, the user may seed the set of players used in the player ranker system, but generally, the system or system operator, e.g., the server or backend operator will seed the set of players. Additionally, in one example, the user may divide the set of players into subsets or categories, but generally the server or backend operator will form subsets or categories.

At 520, the user is presented with two (or more) players of the subset of players. The two players may be paired and displayed to the user in any suitable fashion for selection by the user. Although examples, generally describe the pairing of two players for a head-to-head match-up, in other examples, a set of three more players may be displayed and one or more selected.

The user registers the selection or preference for a player at 530. The selection is stored at 540. The selection may be stored locally with the user (e.g., client) or with the server (either locally or remotely). The method continues to present additional player pairings (which may include entirely new players or the previously selected player with a new player), repeating 520 and 530.

Selections over one or more users may be accumulated and used to rank the players as described herein. For example, various algorithms, look-up tables, or the like may be used to manipulate the results stored in 540, for example, to rank the set of players based on user selection or preferences.

Various aspects and examples of the invention can be implemented in any suitable form including hardware, software, firmware or any combination of these, and, in particular, in program code and associated hardware. Different aspects of the invention may be implemented at least partly as computer software or firmware running on one or more data processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although aspects and examples of the present invention have been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. Sports player ranking logic, comprising:
display logic operable to initiate the display of two players of a plurality of players;
selection logic operable to store a selection of one of the two players by a user; and
ranking logic operable to rank the players based upon user selections of the players.

2. The ranking logic of claim 1, wherein the display logic is operable to display multiple combinations of two players from the plurality of players for selection by a user.

3. The ranking logic of claim 1, wherein the display logic is operable to select a first player and a second player for display, the second player selected based on the ranking of the first player.

4. The ranking logic of claim 3, wherein the selection logic is operable to select the second player based on a non-uniform probability distribution associated with the ranking of the first player.

5. The ranking logic of claim 3, wherein the selection logic is operable to select the first player randomly.

6. The ranking logic of claim 3, wherein the selection logic is operable to select the first player based on a previous user selection.

7. The ranking logic of claim 1, wherein the selection logic is operable to rank the players based on multiple user selections.

8. The ranking logic of claim 1, further comprising logic operable to display selection results of an individual player versus other players of the set of players.

9. Sports player ranking logic, comprising:
logic operable to rank a plurality of players based upon selections by a plurality of users, each of the selections comprising a selection of a player from a subset of the plurality of players.

10. The ranking logic of claim 9, wherein the subset comprises a pairing of two players.

11. The ranking logic of claim 9, wherein the pairing of two players comprises selecting a first player and a second player, the second player selected based on the ranking of the first player.

12. The ranking logic of claim 11, wherein the second player is selected based on a non-uniform probability distribution associated with the ranking of the first player.

13. The ranking logic of claim 11, wherein the first player is selected randomly.

14. The ranking logic of claim 11, wherein the first player is selected based on a previous user selection.

15. Ranking logic, comprising:
display logic operable to display two items from a plurality of items;
selection logic operable to store a selection of one of the two items by a user; and
ranking logic operable to rank the items based upon selections of the items, wherein the display logic is operable to select a first item and a second item for display, and the display logic is operable to select the second item based on a ranking of the first item.

16. The ranking logic of claim 15, wherein selection logic is operable to select the second item based on a non-uniform probability distribution associated with the ranking of the first item.

17. The ranking logic of claim 15, wherein selection logic is operable to select the first item randomly.

18. The ranking logic of claim 15, wherein selection logic is operable to select the first item based on a previous user selection.

19. A method for ranking a plurality of players, the method comprising:
displaying subsets of players from a plurality of players; and
ranking the plurality of players based upon user selections of a player from the displayed subsets of the plurality of players.

20. The method of claim 19, wherein each subset comprises a pairing of two players.

21. The method of claim 20, wherein the pairing of two players comprises selecting a first player and a second player, the second player selected based on the ranking of the first player.

22. The method of claim 21, wherein the second player is selected based on a non-uniform probability distribution associated with the ranking of the first player.

23. The method of claim 21, wherein the first player is selected randomly.

24. The method of claim 21, wherein the first player is selected based on a previous user selection.

25. A computer program product comprising program code for ranking items, the computer program product comprising:
program code operable to initiate the display of two players from a set of players;
program code operable to store a selection of one of the two players by a user; and
program code operable to rank the set of players based upon user selections of the players.

26. The computer program product of claim 25, wherein the program code is further operable to select a first player and a second player for display, the second player selected based on the ranking of the first player.

27. The computer program product of claim 26, wherein the second player is selected based on a non-uniform probability distribution associated with the ranking of the first player.

28. The computer program product of claim 26, wherein the first player is selected randomly.

29. The computer program product of claim 26, wherein the first player is selected based on a previous user selection.

30. The computer program product of claim 25, further comprising program code operable to rank the set of players based on multiple user selections.

31. The computer program product of claim 25, further comprising program code operable to display selection results of an individual player versus other players of the set of players.
